(19) United States
(12) Patent Application Publication
(10) Pub. No.: US 2009/0248432 A1
(43) Pub. Date: Oct. 1, 2009

(54) HEURISTIC MATCHING METHOD FOR USE IN FINANCIAL SYSTEMS

(76) Inventors: J. Michael Earley, JR., Amherst, NH (US); Daniel J. Dykens, JR., Norwell, MA (US); David F. Earley, Duxbury, MA (US)

Correspondence Address: GAUTHIER & CONNORS, LLP, 225 FRANKLIN STREET, SUITE 2300, BOSTON, MA, 02110, US

(21) Appl. No.: 12/060,549

(22) Filed: Apr. 1, 2008

(51) Int. Cl. G06Q 99/00

(52) U.S. Cl. 705/1

(57) ABSTRACT

A heuristic method is described for use with a financial system, wherein the method receives a newly added research item, extracts a text-based index from the newly added research item, applying a plurality of heuristics to said extracted text-based index, matches results of heuristics application with each of the following entity types: companies contacts, industries, themes, and ideas, and, upon detecting a match, creating a bidirectional link between the newly added research item and the matching entity type. The results of the detected match is then stored in a database. The heuristics comprises any of, or a combination of, the following: heuristics to match the text-based index to a subset of existing research items that have been pre-selected, heuristics to match the text-based index to a company's ticker symbol, (3) heuristics to maintain a problem ticker list that is used to negate matches for tickers in said text-based index that can also represent common abbreviations, (4) heuristics to convert said extracted text-based index to a base or root form, and (5) heuristics to remove short, high frequency, common, and low relevance words from said extracted text-based index;

### RELATED APPLICATIONS

This application is related to the application entitled, “METHOD FOR AUTOMATICALLY LINKING A DATA ELEMENT TO EXISTING RESEARCH,” which is incorporated by reference in its entirety.

### BACKGROUND OF THE INVENTION

1. Field of Invention

The present invention relates generally to the field of financial systems. More specifically, the present invention is related to a heuristic matching method for use in financial systems.

2. Discussion of Prior Art

The vast majority of institutional research professionals are conducting research in one of two ways. Many research professionals are taking notes using a word processing application such as Microsoft Word™. They then save those notes to a shared server within their office which their colleagues also have access to. These shared servers typically have hundreds or thousands of folders set up with ticker symbols or company names. The research professional will save their notes in the folder of the company that they are focusing their research attention on. This method of saving research makes this research available to other research and investment professionals within the investment firm but there is no alerting mechanism to alert colleagues of this new information. The second widely adopted method of saving research is done within email applications such as Microsoft Outlook™. The research professional operating under this method will type up their notes within the email application and email the research to their colleagues. After the research is sent the sender typically will save a copy in their outbox or they will create a folder within their email application with a ticker symbol or company name on each folder. This method provides for alerting but many emails go unnoticed due to the high volume of emails received on the client's side. The folders are also not accessible by other colleagues within the firm. Often times, a research note pertains to multiple companies, people, industries and investment themes. These notes that pertain to numerous companies, people, industries and investment themes are not typically copied and saved in all of the corresponding folders of the companies, people, industries and investment themes that are mentioned within the note. As an example a research professional conducting due diligence on a specific company, such as Apple Computer®, will likely take a note that references Apple's executives and the executives of their key suppliers and competitors. This note may also reference the Wall Street analysts that conduct research on Apple. This most likely mentions the companies that Apple competes with as well as their key suppliers. Under the current workflow adopted by the vast majority of research professionals, this note will often be saved within the AAPL folder. As a result, none of the pertinent information relating to the other companies, people, industries and investment themes referenced within this note can be found in more intuitive locations and valuable information is often never made available to other research and investment professionals within the firm.

There are two other commercial research systems on the market. The systems are offered by Tamale Software® and Code Red Inc®. Both these systems require that their own servers be installed on the clients' premises and these applications do not automatically suggest links to relevant items such as people, companies, industries and investment themes. Tamale research only allows their users to link items to companies and this process is done manually. For example, if a research professional wanted to link a person to another person, they would have to link each of them to the same ticker symbol (company) even if these people do not both work at that company. These relationships often do not make much sense and they are very cumbersome to establish. Code Red's product also requires their clients to manually link items together which is time consuming.

What is absent in the prior art research systems is a robust heuristic matching method that helps link research records. Whatever the precise merits, features, and advantages of the above mentioned prior art research systems, none of them achieves or fulfills the purposes of the present invention.

### SUMMARY OF THE INVENTION

The present invention provides a heuristic method for use with a financial system comprising the steps of: (a) receiving a newly added research item; (b) extracting a text-based index from the newly added research item; (c) applying a plurality of heuristics to the extracted text-based index, wherein the heuristics comprises any of, or a combination of, the following: (1) user pre-selection heuristics to match the text-based index to a subset of existing research items that have been pre-selected, (2) ticker symbol heuristics to match the text-based index to a company's ticker symbol, (3) problem ticker heuristics to maintain a problem ticker list that is used to negate matches for tickers in the text-based index that can also represent common abbreviations, (4) word or phrase stemming heuristics to convert the extracted text-based index to a base or root form, and (5) stop word heuristics to remove short, high frequency, common, and low relevance words from the extracted text-based index; (d) matching results of application of heuristics in (c) with each of the following entity types: company contacts, industries, themes, and ideas; (e) upon detecting a match in (d), creating a bidirectional link between the newly added research item and the matching entity type in (d); and (f) storing a record of detected match in (d) in a database.

The present invention also provides an article of manufacture comprising computer usable medium having computer readable program code to implement the above-described method.

### BRIEF DESCRIPTION OF THE DRAWINGS

FIG. 1 illustrates the interface for adding a new note.

FIG. 2 illustrates an interface that is presented to the user to select objects to link to the current note that is being created.

FIG. 3 illustrates an example showing automatic suggested links.

FIG. 4 illustrates a flow chart associated with the present invention's heuristic linking algorithm.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

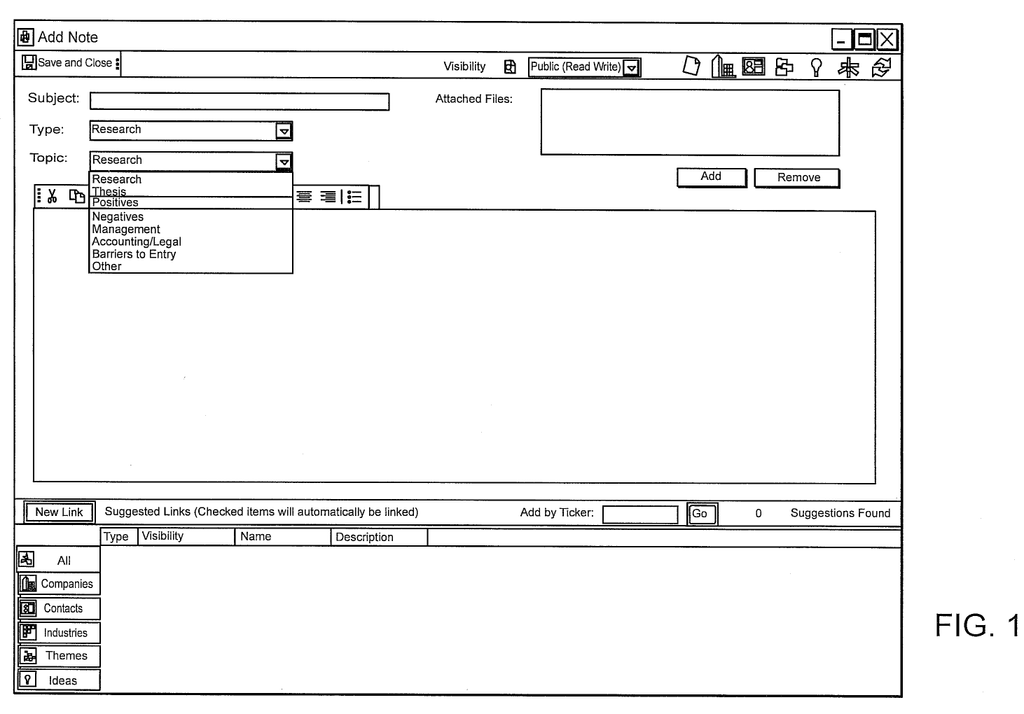

FIG. 1 illustrates the interface for adding a new note. When a new note is created, the user is able to specify a subject of the note (via the field titled “Subject:”). The user is also able to classify the type of note by picking, from a pull down menu, a type to be associated with the new note to be created. Additionally, the users are also able to specify a topic to associate the new note to be created by picking from a pull down menu. Further, the user can also choose to attach one or more files to the note to be created by choosing the “Add” option shown in FIG. 1. If an attached file needs to be removed, the user can select the file in the “Attached Files” box and click on the “Remove” button.

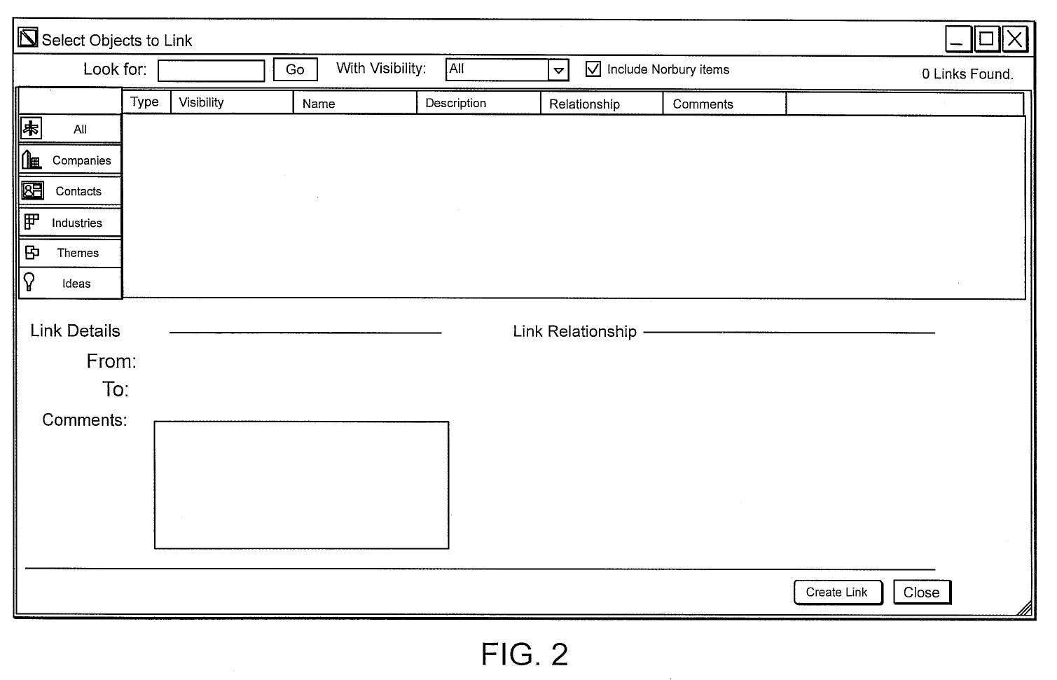

In the interface shown in FIG. 2, the user is able to link the note to be created to a specific company, contact, industry, theme, or idea by clicking on the button titled “New Link”. FIG. 2 illustrates an interface that is presented to the user to select objects to link to the current note that is being created.

Each newly added research item is associated with an unique entity ID and a bidirectional link between two research items represented by a database record (i.e., a link record) that binds two research items together as a link using each item's unique entity ID. A link record may also contain a link note that further describes the link. A link note may be entered by an end user, or programmatically by the process that originated the link. A link record may also contain a link relationship which specifies by numeric identifier the nature of a link between two entities (i.e. employer/employee, investor, industry expert, etc). Since links may exist between all manner of entities, the list of possible link relationships encompasses those that exist between the set (permuted) of: Company, Contact, Industry, Theme, Idea, and Note. Examples of link relationships include, but are not limited to: Employer/Employee, Industry Participant, Board Member, Vendor, Supply Chain, etc. Link nature can be identified using a link flag that identifies the specific link relationship (e.g., employee/employee, supply chain participant, industry expert, etc.).

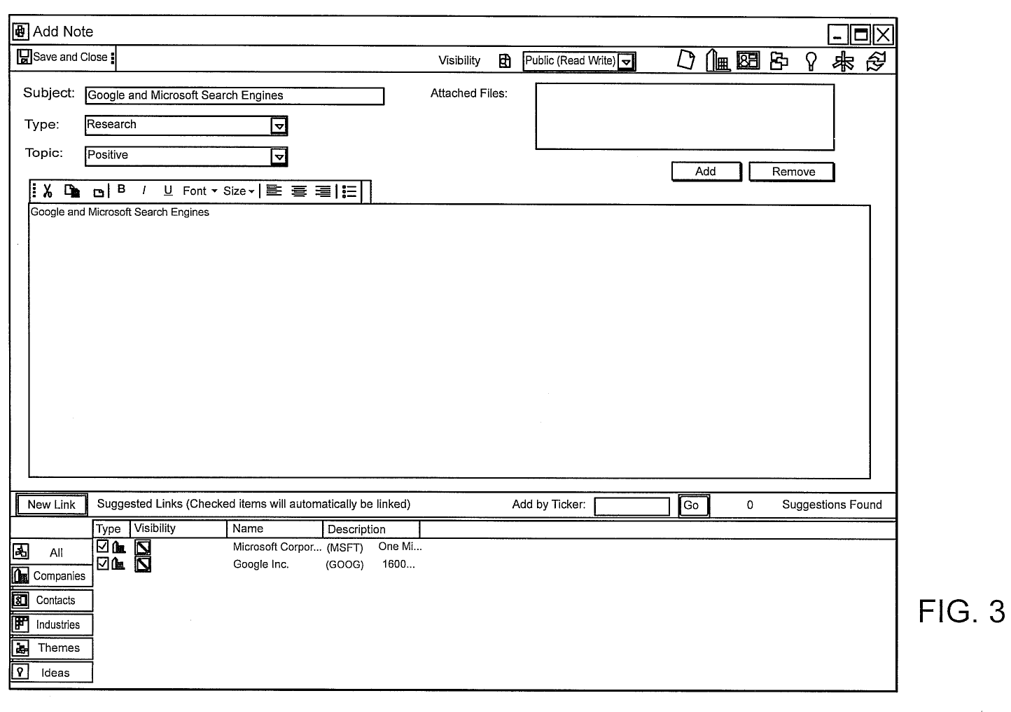

The present invention is also able to automatically suggest links based on the content of the note. FIG. 3 illustrates such an example. In this example, the user starts by adding a new note. When the user types the phrase “Google and Microsoft Search Engines” in the “Subject” field, the present invention's method automatically identifies company names, i.e., Google™ and Microsoft™, in the typed phrase and the present invention's method automatically links existing research for each of these companies. The “Suggested Links” pane in the interface shown in FIG. 12c is automatically populated with the suggested links generated based on parsing the subject line and the content of the note.

Alternatively, the user can also manually create a link to the newly created note to a specific company, contact, industry, theme or idea.

The present invention provides for a method of matching a new item of financial research to an existing repository of financial research items such that the new research item becomes an interlinked, indexed member of the existing repository, and is also linked to other relevant research items, wherein the newly created research item is capable of being subsequently linked to newly introduced financial research items.

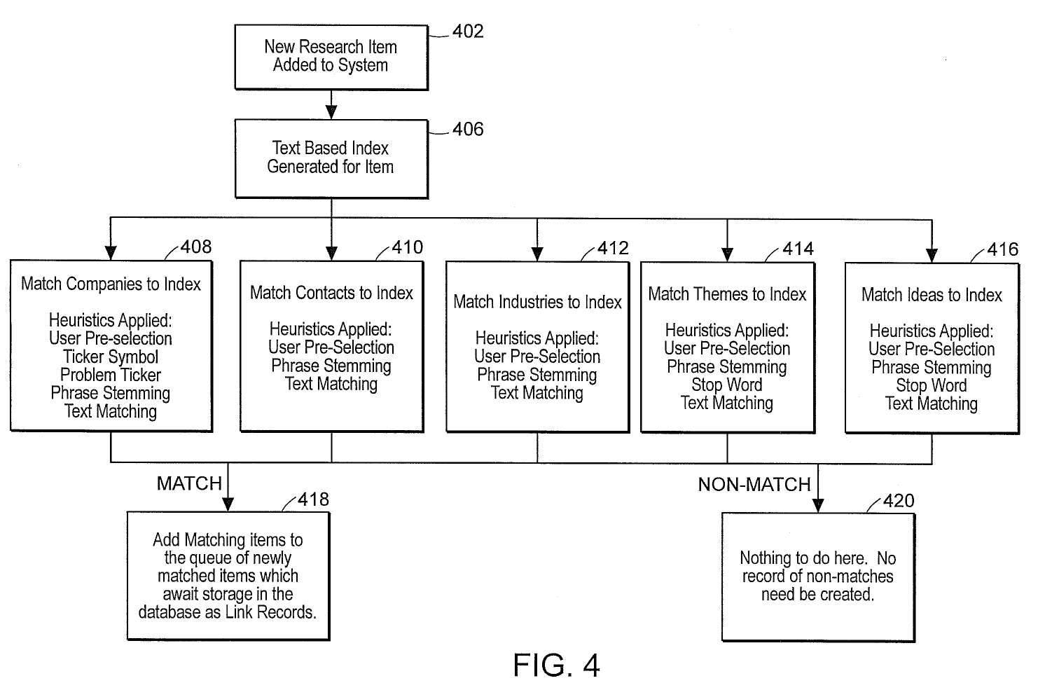

FIG. 4 illustrates a flow chart associated with the present invention's heuristic linking algorithm 400.

In step 402, a new source item (any item of financial research that, in part or whole, can be represented digitally on a computer or network) is added to the system, and, in step 404, a text-based index is generated for the source item. The text-based index is used to generate potential links to existing financial research. The text-based index can be generated via API (that have, for example, been published for the source type) by a program capable of manipulating the source item in its native state (e.g., Adobe®, MS Word™, MS Excel™, etc), or by a custom/proprietary program capable of rendering a text-based index via instrumentation of a known document format (e.g. XML/HTML/ASCII parsing). In practice, source items include but are not limited to: web pages, office productivity application documents, instant message conversation text, personal contact data from any source, corporate name and ticker information from any source, email data and attachments, manually entered content, etc.

It should be noted that the mention of office productivity application documents should not be restricted exclusively to Microsoft Office™ documents. Other office productivity documents, including ASCII-based formats and documents in other productivity suite formats, such as SUN Microsystems' StarOffice™ format, fall within the scope of the present invention.

Matching of an entity type to the source text-based index is accomplished along a dedicated code-path. Each of these processes can be performed in parallel, or in serial fashion. The following five processes are performed in parallel, or in a serial fashion: match companies to index 408; match contacts to index 410; match industries to index 412; match themes to index 414; and match ideas to index 416.

In the ‘match companies to index’ step 408, heuristics applied include: user pre-selection, ticker symbol, problem ticker, phrase stemming, and text matching. In the ‘match contacts to index’ step 410, heuristics applied include: user pre-selection, phrase stemming, and text matching. In the ‘match industries to index’ step 412, heuristics applied include: user pre-selection, phrase stemming, and text matching. In the ‘match themes to index’ step 414, heuristics applied include: user pre-selection, phrase stemming, stop word, and text matching. In the ‘match ideas to index’ step 416, heuristics applied include: user pre-selection, phrase stemming, stop word, and text matching.

Once Heuristics are applied and Matching is performed, valid matches are stored in the database as Research Links. Non-matching items do not result in the generation of a Link Record.

User Pre-Selection Heuristic

User Pre-Selection Heuristic involves matching of a text-based index to a subset of existing research items that have been pre-selected by a user, thereby reducing the volume of existing research data that must be processed by the matching algorithm. In one embodiment, this pre-selection can be accomplished by way of dashboard configuration, where each element that is added to a dashboard view is likewise included as a candidate for heuristic matching.

Ticker Symbol Heuristic

Ticker symbol heuristic involves the matching of a company's ticker symbol to the provided text based index for the purpose of linking the existing research item (the company) to the new research item. This heuristic can be tuned for case-sensitivity and short-ticker exclusion. In practice, upper-case matching and short-ticker inclusion have produced the best results (i.e. fewest false positives) at this stage of heuristic matching for companies. Short Ticker Exclusion is a heuristic that can be applied when suggesting links based on ticker. The heuristic is also referred to as “short ticker exclusion/inclusion.” In one embodiment, the short ticker exclusion heuristic is excluded because the “problem ticker list heuristic” is more effective and adequately covers the “short ticker” case.

Problem Ticker Heuristic

Problem ticker heuristic involves the maintenance and application of a problem ticker list that is used to negate matches for tickers that can also represent common abbreviations (e.g. AM, PM, RE, NH, etc.). Matches to problem tickers are excluded at this phase of heuristic matching. This heuristic can be tuned such that problem tickers are not excluded. This heuristic can be maintained either remotely or locally, by either a service provider or an end user.

Word and Phrase Stemming Heuristic

Word and phrase stemming heuristic involves the transforming of a Contact's name, a Company's name, or any other research item's textual representation to a base or root form, such that matching of words that are unlike in spelling yet identical in relevance can be achieved. This heuristic is characterized by the trimming of accolades from a contact prior to matching (e.g. removing Mr., Dr., Mrs., etc). This heuristic is characterized by the trimming of corporate abbreviations from a Contact prior to matching (e.g. removing Inc., LLC., Incorporated, etc.), which is referred to as “company name stemming.”

Stop Word Heuristic

Stop word heuristic involves the removal of short, high frequency, common, and low relevance words from a text based index or existing research prior to matching (e.g. the, of, it, etc.)

If all configured heuristics are satisfied then a text matching process is applied. If a match is detected, then a bidirectional link is created between the new research item and the existing research item. A record of the match is stored in a database so that related items can later be retrieved based on this match.

Although the term bidirectional is used with respect to the links, it should be noted that this reference does not indicate that linked items are directional or have a parent/child relationship.

Heuristic matching can be applied to research items that originate or are initiated by a current user of the system. Heuristic matching can be applied to research items that originate automatically via the underlying or programmatic workings of the system.

Additionally, the present invention provides for an article of manufacture comprising computer readable program code contained within implementing one or more modules to implement a heuristic matching method for use in a financial system. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

The present invention provides for an article of manufacture comprising a computer usable medium having computer readable program code embodied therein which implements a heuristic method for use with a financial system, the medium comprising: (a) computer readable program code aiding in receiving a newly added research item; (b) computer readable program code extracting a text-based index from the newly added research item; (c) computer readable program code applying a plurality of heuristics to the extracted text-based index, wherein the heuristics comprising any of, or a combination of, the following: (1) user pre-selection heuristics to match the text-based index to a subset of existing research items that have been pre-selected, (2) ticker symbol heuristics to match the text-based index to a company's ticker symbol, (3) problem ticker heuristics to maintain a problem ticker list that is used to negate matches for tickers in the text-based index that can also represent common abbreviations, (4) word or phrase stemming heuristics to convert the extracted text-based index to a base or root form, and (5) stop word heuristics to remove short, high frequency, common, and low relevance words from the extracted text-based index; (d) computer readable program code matching results of application of heuristics in (c) with each of the following entity types: companies contacts, industries, themes, and ideas; (e) computer readable program code, upon detecting a match in (d), creating a bidirectional link between the newly added research item and the matching entity type in (d); and (f) computer readable program code issuing instructions to store a record of detected match in (d) in a database.

### Conclusion

A system and method has been shown in the above embodiments for the effective implementation of a heuristic matching algorithm for use in financial systems. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats.

1. A heuristic method for use with a financial system comprising the steps of:
a. receiving a newly added research item;
b. extracting a text-based index from said newly added research item;
c. applying a plurality of heuristics to said extracted text-based index, said heuristics comprising any of, or a combination of, the following: (1) user pre-selection heuristics to match said text-based index to a subset of existing research items that have been pre-selected, (2) ticker symbol heuristics to match said text-based index to a company's ticker symbol, (3) problem ticker heuristics to maintain a problem ticker list that is used to negate matches for tickers in said text-based index that can also represent common abbreviations, (4) word or phrase stemming heuristics to convert said extracted text-based index to a base or root form, and (5) stop word heuristics to remove short, high frequency, common, and low relevance words from said extracted text-based index;
d. matching results of application of heuristics in (c) with each of the following entity types: companies contacts, industries, themes, and ideas;
e. upon detecting a match in (d), creating a bidirectional link between said newly research item and the matching entity type in (d); and
f. storing a record of detected match in (d) in a database.

2. The heuristic method of claim 1, wherein said text-based index is extracted via an Application Programming Interface (API) that is capable of manipulating said newly added research item in its native state.

3. The heuristic method of claim 1, wherein said text-based index is generated based on parsing any of the following document formats: XML, HTML, or ASCII.

4. The heuristic method of claim 1, wherein said newly added research item is any of the following: office productivity document, instant message conversation, contact data, company name, ticker information, email data, and manually entered content.

5. The heuristic method of claim 1, wherein each heuristic is implemented using a dedicated code path and said plurality of heuristics are applied in a serial manner.

6. The heuristic method of claim 1, wherein each heuristic is implemented using a dedicated code path and said plurality of heuristics are applied in a parallel fashion.

7. The heuristic method of claim 1, wherein said ticker symbol heuristic is further tuned for case-sensitivity and short-ticker exclusion.

8. The heuristic method of claim 1, wherein said word and phrase stemming heuristic comprises any of the following trimming operations: trimming of accolades or trimming of corporate abbreviations.

9. The heuristic method of claim 1, wherein said database is remotely located and is accessible over a network.

10. The heuristic method of claim 9, wherein said network is any of the following: local area network (LAN), wide area network (WAN), or the Internet.

11. An article of manufacture comprising a computer usable medium having computer readable program code embodied therein which implements a heuristic method for use with a financial system, said medium comprising:
g. computer readable program code aiding in receiving a newly added research item;
h. computer readable program code extracting a text-based index from said newly added research item;
i. computer readable program code applying a plurality of heuristics to said extracted text-based index, said heuristics comprising any of, or a combination of, the following: (1) user pre-selection heuristics to match said text-based index to a subset of existing research items that have been pre-selected, (2) ticker symbol heuristics to match said text-based index to a company's ticker symbol, (3) problem ticker heuristics to maintain a problem ticker list that is used to negate matches for tickers in said text-based index that can also represent common abbreviations, (4) word or phrase stemming heuristics to convert said extracted text-based index to a base or root form, and (5) stop word heuristics to remove short, high frequency, common, and low relevance words from said extracted text-based index;
j. computer readable program code matching results of application of heuristics in (c) with each of the following entity types: companies contacts, industries, themes, and ideas;
k. computer readable program code, upon detecting a match in (d), creating a bidirectional link between said newly added research item and the matching entity type in (d); and
l. computer readable program code issuing instructions to store a record of detected match in (d) in a database.

12. The article of manufacture of claim 11, wherein said text-based index is extracted via computer readable program code implementing an Application Programming Interface (API) that is capable of manipulating said newly added research item in its native state.

13. The article of manufacture of claim 11, wherein said text-based index is generated based on computer readable program code parsing any of the following document formats: XML, HTML, or ASCII.

14. The article of manufacture of claim 11, wherein said newly added research item is any of the following: office productivity document, instant message conversation, contact data, company name, ticker information, email data, and manually entered content.

15. The article of manufacture of claim 11, wherein each heuristic is implemented using computer readable program code providing a dedicated code path and said plurality of heuristics are applied in a serial manner.

16. The article of manufacture of claim 11, wherein each heuristic is implemented using computer readable program code providing a dedicated code path and said plurality of heuristics are applied in a parallel fashion.

17. The article of manufacture of claim 11, wherein said medium further comprises computer readable program code to further tune ticker symbol heuristic for case-sensitivity and short-ticker exclusion.

18. The article of manufacture of claim 11, wherein said word and phrase stemming heuristic comprises any of the following trimming operations: trimming of accolades or trimming of corporate abbreviations.

19. The article of manufacture of claim 11, wherein said issued instructions to store a record comprise instructions to store a record in remotely located database, said remotely located database accessible over a network.

20. The article of manufacture of claim 19, wherein said network is any of the following: local area network (LAN), wide area network (WAN), or the Internet.
